(19) United States
(12) Patent Application Publication
(10) Pub. No.: US 2026/0226297 A1
(43) Pub. Date: Aug. 6, 2026

(54) COMPOSITION FOR DYEING A SUBSTRATE AND USE THEREOF

(71) Applicant: STAEDTLER SE, Nürnberg (DE)

(72) Inventors: Arno CASTNER, Nürnberg (DE); Anja BOHNER, Nürnberg (DE); Miriam HILDNER, Nürnberg (DE)

(21) Appl. No.: 19/150,593

(22) PCT Filed: Jan. 29, 2024
(86) PCT No.: PCT/EP2024/025052

§ 371 Date: Jul. 24, 2025

(30) Foreign Application Priority Data
Feb. 3, 2023 (DE) 10 2023 102 694.1

(51) Int. Cl. C09D 11/037; C09D 11/107; C09D 11/16

(52) U.S. Cl. CPC C09D 11/037; C09D 11/107; C09D 11/16

(57) ABSTRACT

A composition for dyeing a substrate, a method for preparing a dyed substrate, and the use of the composition for dyeing a substrate for producing a completely or partially basic-soluble film on a substrate. The composition including: from 20 to 80% by weight of water; from 0.025 to 12.5% by weight of a colorant; and from 5 to 45% by weight of a binder; each based on total weight of the composition. The binder has an acid number of at least 40 mg KOH/g of dry matter, and the composition has a pH of at most 7.5

### FIELD OF THE INVENTION

The present invention relates to a composition for dyeing a substrate.

The invention further relates to a method for preparing a dyed substrate. The invention likewise relates to the use of the composition for dyeing a substrate for producing a completely or partially basic-soluble film on a substrate.

### BACKGROUND OF THE INVENTION

Aqueous inks are known from the prior art and generally comprise water as solvent and pigments or water-soluble dyes as colorants. In addition, they generally comprise further additives, for example surfactants, emulsifiers, preservatives or humectants.

Pigmented inks (dyes) have been known for many years, in particular for artistic applications (painting, drawing, etc.). These are frequently formulated with plastic dispersions as binder and/or with wetting agents. After the ink has dried on a substrate, the ink applications have a permanence with respect to water, i.e. the ink applications are still largely completely maintained after contact with water. This is attributable to the fact that the pigments are per se water-insoluble and, in addition, migrate together with the binder into the absorbent substrate and can thus only be dissolved out again with difficulty.

However, the use of watercolor techniques is desired or necessary for many artistic applications. In this case, different ink layers applied next to one another or one above the other are mixed with one another in order to thus achieve smooth transitions between the ink layers. However, this is not possible or only inadequately possible with dyes which have a high permanence with respect to water.

According to the prior art, therefore, binder-containing dyes, sugars, sugar alcohols or corresponding derivatives are often added. Improved watercolorability can be achieved as a result.

EP 3 613 814 B1 describes, for example, a writing, marking and/or drawing fluid, in particular aqueous, pigmented and/or watercolorable writing, marking and/or drawing fluid, which comprises an aqueous pigment preparation, a binder, a base, sugar or sugar alcohols and a dispersing wetting agent, wherein an aqueous solution of a modified polymer having pigment-affine groups is present as dispersing wetting agent.

However, the improved watercolorability achieved in this way is associated with disadvantages. In the art sector, two different product series are generally required, wherein the first product line comprises watercolorable and therefore water-sensitive inks, whereas the second product line provides permanent inks which also dry in a water-resistant manner on non-absorbent substrates. Not infrequently, more than 60 different hues are provided per product line. The development and provision of two different product lines is therefore associated with high costs and a high outlay for the manufacturer. The end consumer is also frequently forced to restrict himself to a product line for cost reasons.

A further disadvantage is that the smear produced with dyeing compositions according to the prior art dissolves easily when overpainted with another color and smears the latter or the tip of the pencil is soiled by the dissolved color.

### OBJECT OF THE INVENTION

It is therefore the object of the present invention to provide a composition for dyeing a substrate which overcomes the disadvantages of the prior art, in particular to provide a dyeing composition which is adjustably water-resistant and watercolorizable, i.e. which combines the described advantages of both ink classes and avoids the disadvantages.

### DISCLOSURE OF THE INVENTION

This object is achieved according to the subject matter of the independent claims. Preferred embodiments emerge from the dependent claims and the following description.

The object is achieved in particular by a composition for dyeing a substrate comprising:
from 20 to 80% by weight of water;
from 0.025 to 12.5% by weight of a colorant; and
from 5 to 45% by weight of a binder;
each based on the total weight of the composition;
wherein
the binder has an acid number of at least 40 mg KOH/g of dry matter; and
the composition has a pH of at most 7.5.

The object is further achieved by a method for preparing a dyed substrate comprising:
providing a substrate;
applying the composition for dyeing a substrate according to the present invention on at least a part of at least one surface of the substrate and optionally drying the composition to obtain a first film;
providing a watercoloring composition comprising:
   from 40 to 99.5% by weight of water; and
   from 0.5 to 10% by weight of base,
each based on the total weight of the watercoloring composition;
applying the watercoloring composition on at least a part of the first film to obtain an at least partially dissolved first film;
watercoloring the at least partially dissolved first film to obtain a watercolored film; and
drying the watercolored film to obtain a second film.

Finally, the object is achieved by the use of the composition for dyeing a substrate according to the present invention for producing a completely or partially basic-soluble film on an absorbent substrate.

### Composition for Dyeing a Substrate

The composition according to the present invention is suitable and preferably intended for dyeing a substrate.

### Dyeing

The dyeing includes or consists preferably of writing, drawing, painting, printing, or a combination of two or more thereof.

### Substrate

The substrate is preferably an absorbent substrate, for example an absorbent writing substrate, further preferably drawing board or paper, particularly preferably watercolor paper, or a non-absorbent substrate, for example a plastic substrate or a plastic substrate, particularly preferably a plastic or plastic film, or a mixed media substrate, i.e. a combination of different absorbent and non-absorbent materials, or a canvas. Likewise, any other suitable substrate, for instance wood, stone, eggshells, etc., can be provided.

### Water

The composition according to the invention for dyeing a substrate contains water in an amount of 20 to 80 wt %, based on the total weight of the composition. It is preferred that deionized or demineralized water is used as water. It is possible as a result to avoid the introduction of unwanted impurities, such as, for example, hardness formers such as calcium and magnesium or the like.

It can be provided that the composition contains the water as predominant solvent, preferably in an amount of at least 90 wt %, based on the total amount of solvent in the composition. It is particularly preferred that the composition contains water as exclusive solvent.

It is preferred that the composition contains water in an amount of at least 25 wt %, particularly preferably at least 30 wt %, most preferably at least 35 wt %, each based on the total weight of the composition.

It is preferred that the composition contains water in an amount of at most 75 wt %, moreover preferably at most 70 wt %, further preferably at most 65 wt %, more preferably at most 60 wt %, most preferably at most 55 wt %, for example at most 52.15 wt %, each based on the total weight of the composition.

It is preferred that the composition contains water in an amount of 25 to 75 wt %, moreover preferably 30 to 60 wt %, most preferably 35 to 55 wt %, each based on the total weight of the composition.

With the stated preferred amounts of water in the composition, optimized dyeing on the one hand and usability on the other hand could be achieved.

### Further Solvent

It can be provided that water is the only solvent in the composition according to the invention for dyeing a substrate. It can alternatively be provided that the composition according to the invention for dyeing a substrate comprises a further solvent in addition to the water.

It can be provided that the composition for dyeing a substrate contains the further solvent in an amount of at least 1 wt %, particularly preferably at least 5 wt %, most preferably at least 10 wt %, each based on the total weight of the composition.

It is preferred that the composition for dyeing a substrate contains the further solvent in an amount of at most 40 wt %, moreover preferably at most 35 wt %, further preferably at most 30 wt %, more preferably at most 20 wt %, most preferably at most 15 wt %, each based on the total weight of the composition.

It is preferred that the composition for dyeing a substrate contains the further solvent in an amount of 1 to 40 wt %, moreover preferably 5 to 20 wt %, most preferably 10 to 15 wt %, each based on the total weight of the composition.

It is preferred that the further solvent is a water-soluble organic solvent, further preferably an alcohol, moreover preferably a polyhydric alcohol, most preferably glycerol or a glycol, e.g. 1,2-propanediol.

By adding the further solvent to the composition according to the invention, improved solubility behavior can be achieved for substances, for instance pigments or other colorants, which are sparingly soluble in water.

### Colorant

The composition according to the invention for dyeing a substrate contains a colorant in an amount of 0.025 to 12.5 wt %, based on the total weight of the composition.

It is preferred that the colorant is a dye, a pigment, or a mixture of two or more thereof.

As dye, in particular water-soluble dyes, preferably water-soluble dyes based on food dyes and/or acid dyes and/or basic dyes can be used.

The dyes listed below have proven to be particularly suitable:

Food dyes from the group: E 110, CI 15985, Food Yellow 3; E 104, CI 47005, Food Yellow 13; E 102, CI 19140, Food Yellow 4; E 124, CI 16255, Food Red 7; E 127, CI 45430, Food Red 14; E 133, CI 42090, Food Blue 2; E 131, CI 42051, Food Blue 3 and/or Acid dyes from the group: Acid Yellow 23, CI 1910; Acid Red 18, CI 16255; Acid Red 51, CI 45430; Acid Orange 4, CI 16230; Acid Blue 93; Acid Blue 9, CI 42090; Acid Blue 104, CI 42735; Acid Violet 49, CI 42640.

Basic dyes, preferably dyes from the group of xanthene, coumarin, and rhodamine dyes, for example Basic Violet 11, Basic Yellow 40, Basic Blue 3, Basic Blue 7, Basic Red 1, Basic Green 1.

As pigments, preferably organic pigments, moreover preferably phthalocyanine, metal complex, quinacridone, quinophthalone, dioxazine, isoindoline, isoindolinone, benzimidazolone, anthraquinone, arylide, perinone, perylene, naphthol, diketopyrrolopyrrole, or azo pigments, and/or inorganic pigments, such as titanium dioxide, iron oxide, ultramarine, or carbon black, can be used.

A particularly brilliant, strong, and stable dyeing can be achieved by the colorants stated as preferred. It is preferred that the composition contains the colorant in an amount of at least 0.05 wt %, particularly preferably at least 0.075 wt %, each based on the total weight of the composition.

It is preferred that the composition contains the colorant (or the colorant preparation) in an amount of at most 11.25 wt %, moreover preferably at most 10 wt %, further preferably at most 8.75 wt %, more preferably at most 7.5 wt %, most preferably at most 6.25 wt %, for example at most 5 wt %, each based on the total weight of the composition. It can be provided that the pigments are present and used as a constituent of a pigment preparation.

It is preferred that the composition contains the colorant in an amount of 0.025 to 10 wt %, moreover preferably 0.05 to 7.5 wt %, most preferably 0.075 to 5 wt %, each based on the total weight of the composition.

If the colorant is a dye, it is preferred that the composition contains the colorant in an amount of 0.025 to 3 wt %, moreover preferably 0.05 to 2 wt %, most preferably about 0.1 to 1 wt %, each based on the total weight of the composition.

If the colorant is a pigment, it is preferred that the composition contains the colorant in an amount of 0.25 to 10 wt %, moreover preferably 1.25 to 7.5 wt %, most preferably 2.5 to 5 wt %, each based on the total weight of the composition.

In pastel shades, the pigment content can be reduced to 0.025 wt %.

Optimum dyeing can be achieved by the amounts of colorant stated as preferred.

### Binder

The composition according to the invention for dyeing a substrate contains a binder in an amount of 5 to 45 wt %, based on the total weight of the composition. The binder has an acid number of at least 40 mg KOH/g of dry matter. The term “dry matter” in this case relates to the dry matter of the binder, for instance when the binder is used in the form of an aqueous solution or dispersion. The acid number is determined according to DIN ISO EN 2114 in the version valid at the priority date.

It is preferred that the composition for dyeing a substrate contains the binder in a total amount of at least 10 wt %, particularly preferably at least 15 wt %, further preferably at least 20 wt %, moreover preferably 25 wt %, most preferably at least 28 wt %, each based on the total weight of the composition.

It is preferred that the composition for dyeing a substrate contains the binder in a total amount of at most 40 wt %, particularly preferably at most 35 wt %, for example about 30 wt %, each based on the total weight of the composition.

It is preferred that the composition for dyeing a substrate contains the binder in a total amount of 10 to 45 wt %, particularly preferably 20 to 40 wt %, further preferably 25 to 35 wt %, most preferably about 28 to 30 wt %, for example about 36 wt %, each based on the total weight of the composition.

The binder can preferably have an acid number of at least 50 mg KOH/g of dry matter, moreover preferably of at least 60 mg KOH/g of dry matter, further preferably at least 70 mg KOH/g of dry matter, more preferably at least 80 mg KOH/g of dry matter, even more preferably at least 100 mg KOH/g of dry matter, most preferably at least 110 mg KOH/g of dry matter, for example about 120 mg KOH/g of dry matter.

The binder can preferably have an acid number of at most 250 mg KOH/g of dry matter, moreover preferably of at most 220 mg KOH/g of dry matter, further preferably at most 200 mg KOH/g of dry matter, more preferably at most 180 mg KOH/g of dry matter, even more preferably at most 170 mg KOH/g of dry matter, most preferably at most 160 mg KOH/g of dry matter, for example about 130 mg KOH/g or 160 mg KOH/g of dry matter.

The binder can preferably have an acid number of 50 to 250 mg KOH/g of dry matter, moreover preferably of 60 to 220 mg KOH/g of dry matter, further preferably 70 to 220 mg KOH/g of dry matter, more preferably 80 to 180 mg KOH/g of dry matter, even more preferably 100 to 170 mg KOH/g of dry matter, moreover preferably 100 to 160 mg KOH/g of dry matter, most preferably 110 to 160 mg KOH/g of dry matter, such as about 110 to 130 mg KOH/g of dry matter, for example about 130 mg KOH/g of dry matter or 160 mg KOH/g of dry matter.

The binder can preferably be a polymeric binder. The binder can preferably be a polymeric resin. It can be provided that the binder has carboxyl groups and/or nitrile groups and/or sulfonyl groups, preferably has carboxyl groups. Particularly good dyeability, in particular with basic dyes, can be achieved as a result. It is preferably provided that the binder is a polymeric resin which comprises carboxyl-containing monomer units. It is particularly preferred that the binder comprises or consists of a polyacrylate resin.

The binder can be used as solid and/or as aqueous binder preparation in the composition, that is to say can be used in these forms for producing the composition. An aqueous binder preparation in this context is in particular a binder solution or a binder dispersion.

It is preferred that a binder dispersion is used for producing the composition according to the invention. The amount of the binder in the composition is stated in such a case with reference to the total weight of the binder dispersion (including solvent etc.).

It can be provided that the binder dispersion has a pH of at most 7.5, preferably of at most 7, moreover preferably of 1 to 5, further preferably of 1.5 to 3, most preferably of 1.9 to 2.5. It can be provided that the binder dispersion in acidic or neutral pH ranges (at pH≤7) is a low-viscosity, white or translucent binder particle dispersion, wherein these binder particles increasingly go into solution at higher pH values until a clear, transparent and highly viscous solution is formed.

It can be provided that the binder dispersion has a solids content of 30 to 60 wt %, preferably 40 to 50 wt %, particularly preferably 43 to 47 wt %, most preferably 44 to 46 wt %, each based on the total weight of the binder dispersion.

It can be provided that the binder dispersion has a viscosity of 10 to 80 mPa·s. The viscosity can be determined according to ASTM-D2196 in the version valid at the priority date.

It can be provided that the binder dispersion has a density of 1 to 1.2 g/cm³, preferably 1.05 to 1.1 g/cm³, for example of 1.08 g/cm³. The density can be determined according to ASTM D1475 in the version valid at the priority date.

It can be provided that the binder dispersion has a minimum film-forming temperature of 40 to 70° C., preferably of 50 to 60° C., particularly preferably of 55 to 59° C., most preferably of 56 to 58° C., for example of about 57° C. The minimum film-forming temperature can be determined according to ASTM D2354-10 in the version valid at the priority date.

By using a corresponding binder dispersion for producing the composition according to the invention, advantageous mixing with the other constituents of the composition can be achieved. The binder can be an alkali-soluble acrylate dispersion. The binder can be an alkali-soluble polyacrylate dispersion. The binder can be an acidic acrylate dispersion. The binder can be an acidic polyacrylate dispersion. The binder can be an ASE thickener. Commercially available exemplary corresponding binders are, for instance, Joncryl 142, 661, 662, 667 (BASF), Texicryl 13-812, 13-825 (Scott Bader), NeoCryl BT-9, BT-21, BT-24, BT-100, BT-107, BT-207 (DSM), NeoCryl XK-39 (DSM), GLASCOL LE510, LE520 etc. (BASF) or Lucidene 198 (Brenntag). With corresponding alkali-soluble polyacrylate dispersions, the most pronounced effects according to the invention were achieved, namely a particularly readily adjustable water resistance with at the same time good redissolvability by means of the watercoloring composition according to the present invention.

It is preferred that the binder has a glass transition temperature of at least 50° C., preferably more than 50° C. The glass transition temperature can be determined by means of differential thermal analysis (DSC) according to ASTM-E1356 in the version valid at the priority date. Such a glass transition temperature leads to an increased color stability in the dyed substrate.

It can be provided that the binder, in particular the binder dispersion, comprises binder particles. It can be provided that the binder particles have an average particle diameter of at least 50 nm, preferably of at least 100 nm. The particle diameter can be determined by dynamic light scattering according to ASTM E 3247-20 in the version valid at the priority date. By means of correspondingly large diameters of the binder particles, it can be achieved that the ink does not penetrate too deeply into the absorbent substrate, as a result of which the watercolorability, that is to say the later colorability of the ink on the substrate, is improved.

pH-Value

The composition for dyeing a substrate according to the present invention has a pH of at most 7.5, preferably of less than 7.5, moreover preferably at most 7.4, further preferably at most 7.3, further preferably at most 7.2, even more preferably at most 7.1, most preferably at most 7.0, at most 6.9, particularly preferably 6.7, for example at most 6.6, most preferably 6.5.

It is preferred that the composition for dyeing a substrate has a pH of at least 1, particularly preferably at least 3, further preferably at least 4, moreover preferably at least 5, more preferably at least 5.5, most preferably at least 6.

It is preferred that the composition for dyeing a substrate has a pH of 4 to 7.5, particularly preferably 5 to 7.2, further preferably 5.5 to 7, most preferably 6 to 6.5.

### pH Adjusting Agent

It can be provided that the composition further comprises 0.01 to 3 wt %, based on the total weight of the composition, of a pH adjusting agent, in particular a pH adjusting agent which is suitable for adjusting the pH-value of the composition for dyeing a substrate to a pH-value of at most 7.5, preferably of at most 7. The pH adjusting agent can be a base or a pH buffer. It is preferred that the pH adjusting agent is a base. The base can preferably be an amine, particularly preferably a low-odor amine or an odor-neutral amine, for example N-butylaminoethanol (VantexT, from Eastman), 2-butylaminoethanol (Advantex, from Eastman), triethanolamine (CSC Jäklechemie), 2-amino-2-methylpropanol (AMP, Angus Chemie) or tris(hydroxymethyl)-aminomethane (from Merck).

It is preferred that the composition contains the pH adjusting agent in an amount of at least 0.1 wt %, particularly preferably at least 0.3 wt %, further preferably at least 0.5 wt %, most preferably at least 0.6 wt %, each based on the total weight of the composition.

It is preferred that the composition contains the pH adjusting agent in an amount of at most 2.5 wt %, particularly preferably at most 2 wt %, further preferably at most 1 wt %, most preferably at most 0.75 wt %, each based on the total weight of the composition.

It is preferred that the composition contains the pH adjusting agent in an amount of 0.1 to 3 wt %, particularly preferably 0.3 to 2 wt %, further preferably 0.5 to 1 wt %, most preferably 0.6 to 0.75 wt %, each based on the total weight of the composition.

The properties of the composition and of the film produced therewith can be adjusted in a targeted manner by corresponding pH adjusting agents in the corresponding amounts.

### Preservative/Biocide

It can be provided that the composition further comprises 0.01 to 0.5 wt %, based on the total weight of the composition, of a preservative and/or a biocide. Preferred preservatives are, for instance, a mixture of tert-butyl hydroperoxide and monophenyl glycol ether, particularly preferably a mixture of 12 to 60 wt % tert-butyl hydroperoxide and 3 to 50 wt % monophenyl glycol ether, or a mixture of 1,6-dihydroxy-2,5-dioxahexane and tetramethylolacetylenediurea. Such a preservative is particularly suitable for aqueous solutions and emulsions. A preferred biocide is, for example, a mixture of 2-bromo-2-nitropropane-1,3-diol and 2-octyl-2H-isothiazol-3-one or a mixture of BIT (1,2-benzisothiazolin-3-one), MIT (2-methyl-4-isothiazolin-3-one) and OIT (2-octyl-2H-isothiazol-3-one), which in particular prevents contamination. A further preferred biocide is a mixture of CIT/MIT in a weight ratio of 3:1. A further preferred biocide is 2-bromo-2-nitropropane-1,3-diol. A further preferred biocide is 2-octyl-2H-isothiazol-3-one. A further preferred biocide is phenoxyethanol.

It is preferred that the composition contains the preservative and/or the biocide in a total amount of at least 0.05% by weight, more preferably at least 0.1% by weight, further preferably at least 0.15% by weight, most preferably at least 0.2% by weight, each based on the total weight of the composition.

It is preferred that the composition contains the preservative and/or the biocide in a total amount of at most 0.4 wt %, particularly preferably at most 0.3 wt %, further preferably at most 0.25 wt %, most preferably at most 0.2 wt %, each based on the total weight of the composition.

It is preferred that the composition contains the preservative and/or the biocide in a total amount of 0.05 to 0.4 wt %, particularly preferably 0.1 to 0.3 wt %, further preferably 0.15 to 0.25 wt %, most preferably about 0.2 wt %, each based on the total weight of the composition.

### Humectant

It can be provided that the composition further comprises 0.01 to 20 wt %, based on the total weight of the composition, of a humectant. Preferably, the humectant is an organic polyol and/or polyglycol and/or sugar and/or a sugar alcohol and/or a corresponding derivative, for example a sugar amine, particularly preferably selected from the group consisting of diethylene glycol, propylene glycol, 1,2-propanediol, glycerol, trimethylolpropane, ditrimethylolpropane, neopentyl glycol, erythritol, pentaerythritol, glucose, fructose, mannose, invert sugar, sucrose, sorbitol, xylitol, mannitol, and mixtures thereof, particularly preferably 1,2-propanediol. It is preferred that the composition contains the humectant in an amount of at least 1 wt %, particularly preferably at least 5 wt %, further preferably at least 7.5 wt %, most preferably at least 10 wt %, each based on the total weight of the composition.

It is preferred that the composition contains the humectant in an amount of at most 17.5 wt %, particularly preferably at most 15 wt %, further preferably at most 13.5 wt %, each based on the total weight of the composition.

It is preferred that the composition contains the humectant in an amount of 1 to 17.5 wt %, particularly preferably 5 to 15 wt %, further preferably 7.5 to 14.5 wt %, most preferably about 10 to 13.5 wt %, each based on the total weight of the composition.

Corresponding humectants in corresponding concentrations improve the application properties of the composition. In addition, drying out of the composition prior to use is prevented.

The humectant can also act as a film-forming agent and/or as a cap-off additive. A cap-off additive improves the “cap-off time”. “Cap-off time” is to be understood as the time that a writing instrument or a writing system can remain open, i.e. unclosed, lie, be stored or remain unused, without drying out in the process.

Improved film formation leads to more stable and more homogeneous smears.

### Surfactant/Surfactant Substance

It can be provided that the composition further comprises 0.01 to 7 wt %, based on the total weight of the composition, of a surfactant and/or a surfactant substance.

The surfactant can be an emulsifier, a dispersant, a stabilizer or a substrate wetting agent, preferably a silicone surfactant, a fatty alcohol ether sulfate, a fatty alcohol ether phosphate, a fatty alcohol phosphate ester, a sulfosuccinate, or the like.

The surfactant is preferably a nonionic surfactant, an anionic surfactant or an amphoteric surfactant.

Stabilizers in the sense of the present disclosure are, in particular, surfactant substances which stabilize the colloidal particle system against reagglomeration or coagulation by adsorption at the particle interfaces by means of steric, electrostatic or electrosteric interactions and thus prevent sedimentation, syneresis, particle size increase and viscosity increase.

Nonionic surfactants in the sense of the present disclosure can be classified according to the following system. This is the system described by the company Atlas Chemie “HLB-System” (Hydrophilic-Lipophilic-Balance). In the HLB system, each emulsifier is assigned a numerical value, which is called HLB value. The HLB value indicates the hydrophilic-lipophilic equilibrium.

All emulsifiers comprise both hydrophilic and lipophilic groups. A lipophilic emulsifier has a low HLB value of below 9.0 and a hydrophilic emulsifier has a high HLB value of above 11.0. Emulsifiers with low HLB values tend to be oil-soluble, while emulsifiers with high HLB values are water-soluble. For example, a water-soluble emulsifier is used when the end product can be diluted with water. O/W emulsifiers have HLB values of between 8 and 18. Hydrophilic emulsifiers with a high HLB value promote the formation of an O/W emulsion.

In the composition according to the invention, commercial emulsifiers which are obtainable, for example, as viscous solutions and which have been produced by reaction of ethylene oxide with hydrogenated castor oil and can be composed, for example, of 90% by weight of hydrogenated castor oil, 5% by weight of 1,2-propylene glycol and 5% by weight of water can preferably be used as non-ionic solubilizers. Constituents of such emulsifiers can also be fatty acid glycerol polyethylene glycol esters and fatty acid polyethylene glycol esters. They represent the hydrophobic part of the products. The hydrophilic part can consist of polyethylene glycol and glycerol ethoxylate.

Possible emulsifiers which can be considered are preferably nonionic emulsifiers from the groups listed below: alcohol fatty acid esters, ethylene fatty acid esters, polyethylene glycol fatty acid esters, glycerol or polyfatty acid esters, sorbitol fatty acid esters, pentaerythritol fatty acid esters, fatty acid esters of glycerol esters, sucrose fatty acid esters, alcohol polyglycol ethers, fatty acid polyglycol ethers, fatty acid ester polyglycol ethers, fatty amine polyglycol ethers, polyglycol ethers of fatty acid alkanolamides, polyglycol ethers of fats and oils, polypropylene glycol polyglycol ethers, lanolin polyglycol ethers, alcohol polypropylene glycol ethers, fatty acid polypropylene glycol ethers, polypropylene glycol ethers of fatty amines, lanolin polypropylene glycol ethers.

It is preferred that the composition contains the surfactant and/or the surfactant substance in a total amount of at least 0.1 wt %, particularly preferably at least 1 wt %, further preferably at least 1.5 wt %, most preferably at least 2 wt %, each based on the total weight of the composition.

It is preferred that the composition contains the surfactant and/or the surfactant substance in a total amount of at most 5 wt %, particularly preferably at most 4 wt %, further preferably at most 3 wt %, most preferably at most 2.5 wt %, each based on the total weight of the composition.

It is preferred that the composition contains the surfactant and/or the surfactant substance in a total amount of 0.1 to 5 wt %, preferably 1 to 4 wt %, further particularly preferably 1.5 to 3 wt %, most preferably from 2 to 2.5 wt %, for example 2.1 wt %, each based on the total weight of the composition.

Improved ink stability and wettability of the substrate to be dyed can be achieved by corresponding surfactants and/or surfactant substances in corresponding amounts.

### Oligomer/Polymer Having Surfactant/Pigment-Affine Groups

It can be provided that the composition further comprises a compound having surfactant and/or pigment-affine groups, preferably an oligomer having surfactant and/or pigment-affine groups and/or a polymer having surfactant and/or pigment-affine groups in an amount of 0.01 to 5 wt %, based on the total weight of the composition.

Pigment-affine groups in the sense of the present disclosure are anchor groups which are selected depending on the pigment type, for example whether it is organic or inorganic.

Surfactant groups in the sense of the present disclosure are groups having an affinity to surfaces and interfaces, for example of glass, metal, plastic, air, binder particles (mineral or organic) or pigments (mineral or organic).

In particular for use together with inorganic or mineral pigments (TiO₂, iron oxide, etc.), compounds having anionic or cationic surfactant and/or pigment-affine groups can be provided, in particular amino, phosphate, quaternary ammonium, sulfonate, sulfonamide, carboxylate groups, etc.

Unmodified organic pigments are usually nonpolar and carry no surface charges. Here, nonionic dispersants having hydrophilic and hydrophobic molecule sections are usually used, the nonpolar sections being attached to the pigment surface via Van der Waals interactions (=>see HLB value). Here, the corresponding nonpolar sections are to be regarded as a pigment-affine group. Exemplary hydrophobic surfactant and/or pigment-affine groups are, for instance, nonylphenol, isotridecyl, isotristyrene, C13 or further branched or linear fatty acid or fatty alcohol groups, siloxane groups, novolac groups.

The addition of such compounds having surfactant and/or pigment-affine groups to the pigmented writing fluid has the effect of stabilizing these with respect to agglomeration, sedimentation, syneresis, viscosity drift, color strength fluctuations, hue change and further ageing effects or of improving the compatibility between binder and colorant.

It is preferred that the composition contains the compound having surfactant and/or pigment-affine groups in a total amount of at least 0.1 wt %, particularly preferably at least 0.5 wt %, further preferably at least 0.75 wt %, most preferably at least 1 wt %, each based on the total weight of the composition.

It is preferred that the composition contains the compound having surfactant and/or pigment-affine groups in a total amount of at most 5 wt %, particularly preferably at most 2.5 wt %, further preferably at most 1.5 wt %, most preferably at most 1 wt %, each based on the total weight of the composition.

It is preferred that the composition contains the compound having surfactant and/or pigment-affine groups in a total amount of 0.1 to 5 wt %, particularly preferably 0.5 to 2.5 wt %, further preferably 0.75 to 1.5 wt %, most preferably about 1 wt %, each based on the total weight of the composition.

### Further Constituents

Furthermore, the addition of co-binders (e.g. acrylate polymers without acid number, etc.) and co-film-forming agents (texanol, butyl diglycol, etc.) can be provided in order to further optimize the film nature and other application properties of the ink.

Likewise, the addition of waxes and further customary additives can be provided inter alia for improving the scratch resistance.

### EMBODIMENTS

In one embodiment, the invention relates to a composition for dyeing a substrate comprising:
from 20 to 80% by weight of water;
from 0.1 to 0.5% by weight of a biocide;
from 0.1 to 20% by weight of a humectant;
from 0.1 to 3% by weight of a pH adjusting agent;
from 0.1 to 7% by weight of a surfactant and/or a surfactant substance;
from 0.1 to 50% by weight of a colorant; and
from 5 to 45% by weight of a binder;
each based on the total weight of the composition;
wherein
the binder has an acid number of at least 40 mg KOH/g of dry matter; and
the composition has a pH of at most 7.5.

In one embodiment, the invention relates to a composition for dyeing a substrate comprising:
from 25 to 75% by weight of water;
from 0.1 to 0.5% by weight of a biocide;
from 2 to 18% by weight of a humectant;
from 0.1 to 4% by weight of a pH adjusting agent;
from 0.1 to 7% by weight of a surfactant and/or a surfactant substance;
from 0.1 to 45% by weight of a colorant;
from 10 to 40% by weight of a binder;
each based on the total weight of the composition;
wherein
the binder has an acid number of at least 50 mg KOH/g of dry matter; and
the composition has a pH of at most 7.5.

### Production of the Composition for Dyeing a Substrate

The production of the composition for dyeing a substrate can be produced by mixing methods known from the prior art, for instance in a mixing kettle, into which the constituents of the composition for dyeing a substrate are added. In this case, the constituents are intensively mixed with one another continuously by means of suitable stirring tools in order to distribute them sufficiently uniformly.

### Method for Preparing a Dyed Substrate

The invention further relates to a method for preparing a dyed substrate.

### Provision of the Substrate

In a first method step, a substrate, preferably an absorbent substrate, for example an absorbent writing substrate, further preferably drawing board or paper, particularly preferably watercolor paper, or a non-absorbent substrate, for example a plastic substrate or a plastic substrate, particularly preferably a plastic or plastic film, or a mixed media substrate, i.e. a combination of different absorbent and non-absorbent materials, or a canvas, is provided for this purpose. Likewise, any other suitable substrate, for instance wood, stone, eggshells, etc., can be provided.

The composition according to the invention can in particular also be used on non-absorbent substrates, i.e. it also has very good watercolorability on such substrates. The composition according to the invention—in contrast to compositions of the prior art—has excellent water resistance independently of the absorbency of the substrate. In particular, rapid and grease-resistant drying of a smear obtained by means of the composition according to the invention can also be obtained on non-absorbent substrates.

### Application and Optional Drying of the Composition for Dyeing a Substrate

In a subsequent second method step, the composition according to the invention for dyeing a substrate is then applied on the substrate.

The composition is applied at least on one surface of the substrate. In this case, the composition is applied at least on a part of the corresponding surface. The application can comprise writing, drawing, painting, printing, spraying, or a combination of two or more thereof. The application can be effected by means of a paintbrush, a pencil, in particular a watercolor pencil, a print head, a fountain pen holder or another customary applicator, or a combination of two or more thereof.

The application can also comprise a further step of applying a further ink application on and/or next to the first application, wherein it can be provided in particular that this further ink application comprises a colorant which is different from the colorant in the first film. The further ink application can be obtained by a second composition for dyeing a substrate according to the present invention, wherein this second composition for dyeing a substrate according to the present invention comprises a colorant which is different from the colorant in the first film. The first ink application and the optional further ink application are converted into the first film as follows.

After application has taken place, the applied composition can optionally be dried on the substrate (or partially in the latter if a part of the composition has penetrated into the absorbent substrate). The drying can be effected at room temperature (23° C.) under normal atmospheric pressure. The drying can be assisted by the supply of heat, passing of a gas flow (air stream) past the composition to be dried, application of a vacuum, etc.

After drying has been completed, a first film is obtained on the substrate (or optionally partially in the absorbent substrate if a part of the composition has penetrated into the absorbent substrate). This first film is largely water-resistant, preferably water-resistant, and can be overpainted with other dyes without being “smeared”, that is to say can be covered without mixing with the other dyes (other compositions for dyeing a, preferably, substrate).

Alternatively, from the applied composition for dyeing a substrate according to the invention, even without a drying step, the first film can be obtained, which is then watercolor, as described below. The method further comprises a step of providing a watercoloring composition comprising 40 to 99.5% by weight of water; and 0.5 to 10% by weight of base, in each case based on the total weight of the watercoloring composition.

The watercoloring composition can be provided by a manufacturer of the composition according to the invention for dyeing a substrate and can be placed on the market together with the composition for dyeing a substrate, for example in the form of a kit in which the composition for dyeing a substrate and the watercoloring composition are placed on the market separately from one another, for example in separate vials or filled into an applicator. In such a case, amine-based bases are preferred in the watercoloring composition. Alternatively, the manufacturer of the composition according to the invention for dyeing a substrate can place only this composition on the market together with instructions for preparing a watercoloring composition by the end consumer by means of freely available means. In such a case, for example, sodium hydrogen carbonate or sodium carbonate are preferred bases.

### Water

It is preferred that deionized or demineralized water is used as water. It is possible as a result to avoid unwanted impurities which, for instance, can have an influence on the stability and durability (hardness formers) of the watercoloring composition.

It can be provided that the watercoloring composition contains the water as predominant solvent, preferably in an amount of at least 90 vol %, based on the total amount of solvent in the watercoloring composition. It is particularly preferred that the watercoloring composition contains water as exclusive solvent.

It is preferred that the watercoloring composition contains water in an amount of at least 50 wt %, particularly preferably at least 70 wt %, further preferably at least 80 wt %, moreover preferably at least 90 wt %, most preferably at least 95 wt %, each based on the total weight of the watercoloring composition.

It is preferred that the watercoloring composition contains water in an amount of at most 99 wt %, based on the total weight of the watercoloring composition.

It is preferred that the watercoloring composition contains water in an amount of 50 to 99.5 wt %, moreover preferably 90 to 99.5 wt %, most preferably 95 to 99 wt %, each based on the total weight of the watercoloring composition. With the stated preferred amounts of water in the watercoloring composition, optimized redissolution of the first film can be achieved.

### Base

The base can preferably be an amine, a low-odor amine or an odor-neutral amine, for example N-butylaminoethanol (VantexT, from Eastman), 2-butylaminoethanol (Advantex, from Eastman), triethanolamine (CSC Jäklechemie), 2-amino-2-methylpropanol (AMP, Angus Chemie) or tris(hydroxymethyl)-aminomethane (from Merck). Likewise, sodium hydrogen carbonate (baking powder, sodium hydroxide) or sodium carbonate (soda) or ammonium hydrogen carbonate (Hirschhorn salt) can be used as base.

It is preferred that the watercoloring composition contains the base in an amount of at least 0.1 wt %, particularly preferably at least 1 wt %, further preferably at least 2 wt %, most preferably at least 3 wt %, each based on the total weight of the watercoloring composition.

It is preferred that the watercoloring composition contains the base in an amount of at most 6 wt %, particularly preferably at most 5 wt %, further preferably at most 4 wt %, most preferably at most 3 wt %, each based on the total weight of the watercoloring composition.

It is preferred that the watercoloring composition contains the base in an amount of 0.1 to 6 wt %, particularly preferably 1 to 5 wt %, further preferably 2 to 4 wt %, most preferably about 3 wt %, each based on the total weight of the watercoloring composition.

### Preservative/Biocide

It can be provided that the watercoloring composition further comprises 0.01 to 0.5 wt %, based on the total weight of the watercoloring composition, of a preservative and/or a biocide.

Preferred preservatives are, for instance, a mixture of tert-butyl hydroperoxide and monophenyl glycol ether, particularly preferably a mixture of 12 to 60 wt % tert-butyl hydroperoxide and 3 to 50 wt % monophenyl glycol ether, or a mixture of 1,6-dihydroxy-2,5-dioxahexane and tetramethylolacetylenediurea. Such a preservative is particularly suitable for aqueous solutions and emulsions. A preferred biocide is, for example, a mixture of 2-bromo-2-nitropropane-1,3-diol and 2-octyl-2H-isothiazol-3-one or a mixture of BIT (1,2-benzisothiazolin-3-one), MIT (2-methyl-4-isothiazolin-3-one) and OIT (2-octyl-2H-isothiazol-3-one), which in particular prevents contamination. A further preferred biocide is a mixture of CIT/MIT in a weight ratio of 3:1. A further preferred biocide is 2-bromo-2-nitropropane-1,3-diol. A further preferred biocide is 2-octyl-2H-isothiazol-3-one. A further preferred biocide is phenoxyethanol.

It is preferred that the watercoloring composition contains the preservative and/or the biocide in a total amount of at least 0.05 wt %, particularly preferably at least 0.1 wt %, further preferably at least 0.15 wt %, most preferably at least 0.2 wt %, each based on the total weight of the watercoloring composition.

It is preferred that the watercoloring composition contains the preservative and/or the biocide in a total amount of at most 0.4 wt %, particularly preferably at most 0.3 wt %, further preferably at most 0.25 wt %, most preferably at most 0.2 wt %, each based on the total weight of the watercoloring composition.

It is preferred that the watercoloring composition contains the preservative and/or the biocide in a total amount of 0.05 to 0.4 wt %, particularly preferably 0.1 to 0.3 wt %, further preferably 0.15 to 0.25 wt %, most preferably about 0.2 wt %, each based on the total weight of the watercoloring composition.

### Binder

It can be provided that the watercoloring composition further comprises 0.1 to 50 wt % of a binder.

It is preferred that the binder is an alkali-stable binder. It can be provided that the binder is gum arabic, a wax, for example beeswax, or a synthetic polymeric binder, preferably a polyacrylate, a polyurethane, a polyester, a sulfopolyester, a maleate resin, or a copolymer of two or more thereof, a polyvinyl alcohol, polyvinylpyrrolidone, etc. For example, the binder can be Acronal 12DE (dispersion of an acrylonitrile-acrylic ester copolymer, BASF) Neocryl XK166N (dispersion of an acrylstyrene copolymer, Covestro) NeoRez R-3972 (polyurethane dispersion, Covestro) Eastek 1000 (colloidal solution of a sulfopolyester, Eastman) or Mowiol 4-88 (polyvinyl alcohol solid resin, from Kuraray).

It is preferred that the watercoloring composition contains the binder in a total amount of at least 1 wt %, particularly preferably at least 5 wt %, further preferably at least 10 wt %, most preferably at least 20 wt %, each based on the total weight of the watercoloring composition.

It is preferred that the watercoloring composition contains the binder in a total amount of at most 45 wt %, moreover preferably at most 40, particularly preferably at most 30 wt %, for example about 28 wt %, each based on the total weight of the watercoloring composition.

It is preferred that the watercoloring composition contains the binder in a total amount of 1 to 45 wt %, particularly preferably 5 to 40 wt %, further preferably 10 to 35 wt %, most preferably about 20 to 30 wt %, for example about 28 wt %, each based on the total weight of the watercoloring composition.

### Surfactant/Surfactant Substance

It can be provided that the watercoloring composition further comprises 0.01 to 7 wt %, based on the total weight of the watercoloring composition, of a surfactant and/or a surfactant substance.

The surfactant can be an emulsifier, a dispersant, a stabilizer or a substrate wetting agent, preferably a silicone surfactant, a fatty alcohol ether sulfate, a fatty alcohol ether phosphate, a fatty alcohol phosphate ester, a sulfosuccinate, a sugar surfactant or the like.

The surfactant is preferably a nonionic surfactant, an anionic surfactant or an amphoteric surfactant.

Stabilizers in the sense of the present disclosure are, in particular, surfactant substances which stabilize the colloidal particle system against reagglomeration or coagulation by adsorption at the particle interfaces by means of steric, electrostatic or electrosteric interactions and thus prevent sedimentation, syneresis, particle size increase and viscosity increase.

Nonionic surfactants in the sense of the present disclosure can be classified according to the following system. This is the system described by the company Atlas Chemie “HLB-System” (Hydrophilic-Lipophilic-Balance). In the HLB system, each emulsifier is assigned a numerical value, which is called HLB value. The HLB value indicates the hydrophilic-lipophilic equilibrium.

All emulsifiers comprise both hydrophilic and lipophilic groups. A lipophilic emulsifier has a low HLB value of below 9.0 and a hydrophilic emulsifier has a high HLB value of above 11.0. Emulsifiers with low HLB values tend to be oil-soluble, while emulsifiers with high HLB values are water-soluble. For example, a water-soluble emulsifier is used when the end product can be diluted with water. O/W emulsifiers have HLB values of between 8 and 18. Hydrophilic emulsifiers with a high HLB value promote the formation of an O/W emulsion.

In the watercoloring composition according to the invention, commercial emulsifiers which are obtainable, for example, as viscous solutions and which have been produced by reaction of ethylene oxide with hydrogenated castor oil and can be composed, for example, of 90% by weight of hydrogenated castor oil, 5% by weight of 1,2-propylene glycol and 5% by weight of water can preferably be used as non-ionic solubilizers. Constituents of such emulsifiers can also be fatty acid glycerol polyethylene glycol esters and fatty acid polyethylene glycol esters. They represent the hydrophobic part of the products. The hydrophilic part can consist of polyethylene glycol and glycerol ethoxylate.

Possible emulsifiers which can be considered are preferably nonionic emulsifiers from the groups listed below: alcohol fatty acid esters, ethylene fatty acid esters, polyethylene glycol fatty acid esters, glycerol or polyfatty acid esters, sorbitol fatty acid esters, pentaerythritol fatty acid esters, fatty acid esters of glycerol esters, sucrose fatty acid esters, alcohol polyglycol ethers, fatty acid polyglycol ethers, fatty acid ester polyglycol ethers, fatty amine polyglycol ethers, polyglycol ethers of fatty acid alkanolamides, polyglycol ethers of fats and oils, polypropylene glycol polyglycol ethers, lanolin polyglycol ethers, alcohol polypropylene glycol ethers, fatty acid polypropylene glycol ethers, polypropylene glycol ethers of fatty amines, lanolin polypropylene glycol ethers.

It is preferred that the watercoloring composition contains the surfactant and/or the surfactant substance in a total amount of at least 0.1 wt %, particularly preferably at least 1 wt %, further preferably at least 1.5 wt %, most preferably at least 2 wt %, each based on the total weight of the watercoloring composition.

It is preferred that the watercoloring composition contains the surfactant and/or the surfactant substance in a total amount of at most 5 wt %, particularly preferably at most 4 wt %, further preferably at most 3 wt %, most preferably at most 2.5 wt %, each based on the total weight of the watercoloring composition.

It is preferred that the watercoloring composition contains the surfactant and/or the surfactant substance in a total amount of 0.1 to 5 wt %, preferably 1 to 4 wt %, further particularly preferably 1.5 to 3 wt %, most preferably from 2 to 2.5 wt %, for example 2.1 wt %, each based on the total weight of the watercoloring composition.

Improved ink stability and wettability of the substrate to be watercolored can be achieved by corresponding surfactants and/or surfactant substances in corresponding amounts.

### Application and Watercoloring

The watercoloring composition provided is applied on at least one part of the first film. The application can be effected by means of a paintbrush, a pencil, in particular a watercolor pencil, a print head, a fountain pen holder or another customary applicator, or a combination of two or more thereof.

By applying the watercoloring composition on the first film, the first film is at least partially “partially dissolved”, i.e. at least a part of the solid from the composition for dyeing a substrate, which is contained in the first film by the drying, in particular corresponding parts of the colorant and of the binder having an acid number of at least 40 mg KOH/g, is dissolved in the watercoloring composition. On account of the acid number of at least 40 mg KOH/g of the binder contained in the composition for dyeing a substrate, the solid constituents of the composition deposited together with this binder are far more soluble or redispersible in the basic (pH>7) than in the neutral or acidic (pH≤7). The base contained in the watercoloring composition therefore assists the process of “partial dissolution”.

The carboxyl groups present of the acidic polymer are completely neutralized by the base of the watercoloring composition, as a result of which the water solubility of the polymer is achieved or this is significantly increased.

Watercoloring is understood here to mean the mixing of different ink layers (identical or different dyes) applied next to one another or one above the other with one another in order to thus achieve smooth transitions between the ink layers.

The steps (1.) of applying the watercoloring composition on at least a part of the first film to obtain an at least partially dissolved first film; and (2.) of watercoloring the at least partially dissolved first film to obtain a watercolored film can be effected at least partially overlapping, i.e. at least partially simultaneously. This means in particular that the film thus partially dissolved can be watercolored even during the application of the watercoloring composition.

### Drying

After watercoloring has taken place, the watercolored film is dried on the substrate (or partially in the latter if a part of the composition has penetrated into the substrate). The drying can be effected at room temperature (23° C.) under normal atmospheric pressure. The drying can be assisted by the supply of heat, passing of a gas flow (air stream) past the composition to be dried, application of a vacuum, etc.

If an amine compound, in particular a readily volatile amine compound, is used as base in the watercoloring composition, the drying step leads to a reprotonation of the binder having an acid number of at least 40 mg KOH/g of dry matter, since the amine compound is released again in the drying step from the ammonium compound, which is obtained by reaction of the amine compound with a proton of the binder having an acid number of at least 40 mg KOH/g of dry matter during the application of the watercoloring composition on at least a part of the first film, and evaporates or volatilizes.

If another base is used in the watercoloring composition, for example a sparingly volatile or non-volatile base, such as an alkali metal hydroxide, it can be provided that an additional fixing step is provided after the drying. This step can be, for example, the application of an acidic aqueous solution, for example by means of “fixing spray”, to the watercolored film.

Alternatively, a lacquering by means of a corresponding aqueous solution of polyvalent metal salts (salts of zinc, aluminum, iron, magnesium, calcium, etc.), which form sparingly soluble compounds with the acidic binder of the watercoloring composition, can be provided.

The second film thus obtained, which can have in particular smooth color transitions, can again be water-resistant.

### Use of the Composition for Dyeing a Substrate

The invention further relates to the use of the composition for dyeing a substrate according to the present invention for producing a completely or partially basic-soluble film on a substrate.

The use according to the invention can comprise in particular the provision of a substrate, preferably an absorbent substrate, for example an absorbent writing substrate, further preferably drawing board or paper, particularly preferably watercolor paper, or a non-absorbent substrate, for example a plastic substrate or a plastic substrate, particularly preferably a plastic or plastic film, or a mixed media substrate, i.e. a combination of different absorbent and non-absorbent materials, or a canvas. Likewise, any other suitable substrate, for instance wood, stone, eggshells, etc., can be provided.

It can be provided that the composition according to the invention for dyeing a substrate is then applied on the substrate.

In this case, the composition is applied at least on a part of the corresponding surface. The application can comprise writing, drawing, painting, printing, spraying, or a combination of two or more thereof. The application can be effected by means of a paintbrush, a pencil, in particular a watercolor pencil, a print head, a fountain pen holder or another customary applicator (e.g. airbrush), or a combination of two or more thereof.

The application can also comprise a further step of applying a further ink application on and/or next to the first application, wherein it can be provided in particular that this further ink application comprises a colorant which is different from the colorant in the first film. The further ink application can likewise be obtained by a composition for dyeing a substrate according to the present invention, wherein this further ink application comprises a colorant which is different from the colorant in the first film. The first ink application and the optional further ink application are converted into the first film as follows.

After application has taken place, the applied composition can be dried on the substrate (or partially in the latter if a part of the composition has penetrated into the substrate). The drying can be effected at room temperature (23° C.) under normal atmospheric pressure. The drying can be assisted by the supply of heat, passing of a gas flow (air stream) past the composition to be dried, application of a vacuum, etc.

### Effect of the Invention

The composition according to the invention for dyeing a substrate is surprisingly adjustably water-resistant and watercolorrizable, i.e. it has both the advantages of water-resistant, binder-containing inks and the advantages of readily watercolorrizable inks and at the same time avoids the disadvantages thereof.

With the aid of the composition according to the invention and the use thereof, in particular in the method according to the invention, the two different types of ink can be combined without diminishing the advantages of the two groups. It is possible to produce only a product range with which it is left to the end customer for which painting technique or for which application purpose he wishes to use the product finally. In addition, even after completion of his work of art, the user can still decide whether he wishes to process it further subsequently with watercolor techniques. A further advantage is that such a prepared watercolor remains water-resistant.

A further advantage is that a plurality of ink layers can be applied one above the other without “smearing” the ink layers lying thereunder. Thus, for example, contours can be pre-drawn with a dark dye, which are then colored with light dyes without blurring the contours (example: combination of yellow and black). This is not possible with compositions according to the prior art. Likewise, it is advantageous that, when overpainting dried ink layers, the tip of the writing instrument no longer soils and therefore does not have to be cleaned in a complicated manner.

### General Definitions

Unless expressly stated otherwise, a feature stated in the singular (a . . . ) also comprises the plural. If, for example, it is stated that the composition according to the invention contains a dye, this also includes the case in which the composition contains a mixture of a plurality of dyes.

Unless expressly stated otherwise, terms such as “comprising”, “containing” etc. comprise the meanings “substantially comprising”, “substantially containing” or “consisting of”.

The amounts stated for the composition according to the invention for dyeing a substrate add up to a total amount of 100 wt % and thus give the total amount of the composition.

Unless expressly stated otherwise, the term “composition” as used herein denotes the “composition according to the invention for dyeing a substrate”.

### WORKING EXAMPLES

### Formulation Example 1 (Black Ink)

35.0 g Water
0.2 g Mixture of 2.5 wt % BIT/4 wt % MIT/1 wt % OIT (Biocide)
10.0 g 1,2-propanediol
4.0 g sorbitol
0.60 g triethanolamine
1.0 g C12-C15 alcohol ethoxylate phosphoric acid ester, DMEA neutralized (compound having
surfactant and/or pigment-affine groups)
0.60 g BYK-348 from BYK-Chemie (silicone surfactant)
20.0 g carbon black pigment
28.6 Neocryl XK-39 from Covestro (alkali-soluble polyacrylate dispersion=>acid number (SZ)=130 mg KOH/g of dry matter)
pH-value of the total composition=6.6

### Formulation Example 2 (Magenta Ink)

52.15 g Water
0.2 g Mixture of 2.5 wt % BIT/4 wt % MIT/1 wt % OIT (Biocide)
12.0 g 1,2-propanediol
3.0 g xylitol
0.75 g triethanolamine
1.0 g Disponil FES 77 from Cognis (C12-C14 fatty alcohol ether sulfate Na salt (30 EO) (compound having surfactant and/or pigment-affine groups)
0.60 g Tego Wet KL 245, from Evonic (silicone surfactant)
0.30 g “Basic Violet 11:1” dye
30.0 g Joncryl 661, BASF (alkali-soluble polyacrylate dispersion with SZ=154 mg KOH/g of dry matter)
pH-value of the total composition=6.5

### Watercoloring Composition

60.0% Water
0.1% Mixture of 2.5 wt % BIT/4 wt % MIT/1 wt % OIT (Biocide)
7.5% Glycerol
28% Acronal 12DE (Binder)
3.0% Advantex (Base)
1.4% Disponil OC 25 (Oleyl cetyl ethoxylate (C16/C18) (25 EO)) (Surfactant)

### Experimental Examples and Procedure

Substrate: Paper, from Hahnemühle, watercolor paper 450 g/m², Ref. No.: 10628410
Applicator: from Pentel. “Aqua Brush Water Tank Brush Broad”
Contact weight: 70 g
Colorimeter: PANTONE CAPSURE

Procedure: Firstly, in each case six 1 mm wide lines of the watercolorable ink according to Formulation Example 1 indicated above were drawn with a defined distance of likewise 3 mm from one another on the substrate (base smear). These smears were dried for 1 hour under standard climate conditions (defined according to DIN EN ISO 139=>23° C., 50% rel. moisture). Subsequently, this base smear was overpainted with the abovementioned applicator briefly in succession twice with water or with the watercoloring composition indicated above.

### Experimental Example 1

Applicator filled with water.

### Experimental Example 2

Applicator filled with the watercoloring composition according to the invention.

### Evaluation

Determination of the color strength of the unpainted interspace between the dyed lines with an assumed color strength of 0%. In comparison with this, the assumed color strength of the dyed lines is 100%.

TABLE 1
Presentation of the experimental results

| | | | Percentage |
|---|---|---|---|
| | | | decrease in the |
| | Formulation | Watercoloring | color strength of |
| | Base smear | composition | the base smear |
| Experimental | Formulation | tap water | 0% |
| Example 1 | Example 1 | | |
| Experimental | Formulation | Watercoloring | about 40% |
| Example 2 | Example 1 | composition | |

As shown in Table 1, the color strength of the interspaces after treatment with tap water is unchanged at 0%.

The color strength of the interspaces after treatment with the watercoloring composition is about 40%.

The features of the invention disclosed in the above description and in the claims can be essential both individually and in any combination for the realization of the invention in its different embodiments.

1-15. (canceled)

16. A composition for dyeing a substrate, comprising:
from 20 to 80% by weight of water;
from 0.025 to 12.5% by weight of a colorant; and
from 5 to 45% by weight of a binder;
each based on total weight of the composition;
wherein
the binder has an acid number of at least 40 mg KOH/g of dry matter; and
the composition has a pH of at most 7.5.

17. The composition for dyeing a substrate according to claim 16, wherein the dyeing is writing, drawing, painting, printing, spraying, or a combination of at least two thereof.

18. The composition for dyeing a substrate according to claim 16, wherein the substrate is an absorbent writing substrate or a non-absorbent substrate.

19. The composition for dyeing a substrate according to claim 18, wherein the substrate is drawing board or paper.

20. The composition for dyeing a substrate according to claim 18, wherein the substrate is a plastic film or a plastic film, a mixed media substrate or a canvas.

21. The composition for dyeing a substrate according to claim 16, wherein the colorant is a dye, a pigment, or a mixture of at least two thereof.

22. The composition for dyeing a substrate according to claim 16, wherein the binder has an acid number of at least 80 mg KOH/g of dry matter.

23. The composition for dyeing a substrate according to claim 16, wherein the binder comprises binder particles.

24. The composition for dyeing a substrate according claim 23, wherein the binder particles have an average particle diameter of at least 50 nm.

25. The composition for dyeing a substrate according to claim 24, wherein the binder particles have an average particle diameter of at least 100 nm.

26. The composition for dyeing a substrate according to claim 16, wherein the binder comprises a polyacrylate resin, preferably polyacrylate resin particles.

27. The composition for dyeing a substrate according to claim 26, wherein the binder comprises polyacrylate resin particles.

28. The composition for dyeing a substrate according to claim 16, wherein the composition has a pH in a range of from 5.5 to 7.0.

29. The composition for dyeing a substrate according to claim 16, further comprising 0.01 to 3 wt %, based on the total weight of the composition, of a pH adjusting agent.

30. The composition for dyeing a substrate according to claim 29, wherein the pH adjusting agent is a base.

31. The composition for dyeing a substrate according to claim 16, further comprising 0.01 to 0.5 wt %, based on the total weight of the composition, of a preservative and/or a biocide.

32. The composition for dyeing a substrate according to claim 16, further comprising 0.01 to 20 wt %, based on the total weight of the composition, of a humectant.

33. The composition for dyeing a substrate according to claim 16, further comprising 0.01 to 7 wt %, based on the total weight of the composition, of a surfactant.

34. A method for preparing a dyed substrate, comprising the steps of:
providing a substrate;
applying the composition for dyeing a substrate according to claim 16 on at least a part of at least one surface of the substrate and optionally drying the composition to obtain a first film;
providing a watercoloring composition comprising:
from 40 to 99.5% by weight of water; and
from 0.5 to 10% by weight of base,
each based on total weight of the watercoloring composition;
applying the watercoloring composition on at least a part of the first film to obtain an at least partially dissolved first film;
watercoloring the at least partially dissolved first film to obtain a watercolored film; and
drying the watercolored film to obtain a second film.

35. A method for producing a completely or partially basic-soluble film on a substrate, comprising the steps of: providing a substrate; and, producing the film on the substrate by using the composition according to claim 16.
